(19) United States
(12) Patent Application Publication
(10) Pub. No.: US 2015/0262412 A1
(43) Pub. Date: Sep. 17, 2015

(54) AUGMENTED REALITY LIGHTING WITH DYNAMIC GEOMETRY

(71) Applicant: QUALCOMM Incorporated, San Diego, CA (US)

(72) Inventors: Lukas Gruber, Graz (AT); Dieter Schmalstieg, Graz (AT); Jonathan Daniel Ventura, Graz (AT)

(21) Appl. No.: 14/593,949

(22) Filed: Jan. 9, 2015

Related U.S. Application Data
(60) Provisional application No. 61/954,554, filed on Mar. 17, 2014.

(51) Int. Cl. G06T 15/50; G06T 19/00

(52) U.S. Cl. CPC G06T 15/50; G06T 19/006

(57) ABSTRACT

Methods for determination of AR lighting with dynamic geometry are disclosed. A camera pose for a first image comprising a plurality of pixels may be determined, where each pixel in the first image comprises a depth value and a color value. The first image may correspond to a portion of a 3D model. A second image may be obtained by projecting the portion of the 3D model into a camera field of view based on the camera pose. A composite image comprising a plurality of composite pixels may be obtained based, in part, on the first image and the second image, where each composite pixel in a subset of the plurality of composite pixels is obtained, based, in part, on a corresponding absolute difference between a depth value of a corresponding pixel in the first image and a depth value of a corresponding pixel in the second image.

### CROSS REFERENCE TO RELATED APPLICATIONS

This application claims the benefit of and priority to U.S. Provisional Application No. 61/954,554, entitled “Augmented Reality Lighting with Dynamic Geometry,” filed Mar. 17, 2014, which is incorporated by reference in its entirety herein.

### FIELD

This disclosure relates generally to apparatus, systems, and methods for augmented reality lighting involving scenes with dynamic geometry.

### BACKGROUND

In computer vision and computer graphics, 3-dimensional (“3D”) reconstruction is the process of determining the shape and/or appearance of real objects and/or the environment. In general, the term 3D model is used herein to refer to a representation of a 3D scene or environment being modeled by a device. 3D reconstruction may be based on data and/or images of an object obtained from various types of sensors including cameras. For example, a handheld camera may be used to acquire information about a 3D scene and produce an approximate virtual model of the scene.

Augmented Reality (AR) applications are often used in conjunction with 3D reconstruction. In AR, real images may be processed to add virtual objects to the image. Some real-time or near real-time AR methods often use simple lighting models that lead to a sub-optimal user experience. For example, one or more of light reflections from objects in the scene, objects shadows, and various other lighting effects may be omitted or modeled in a manner that makes scenes appear artificial. In instances where one or more of these effects are modeled, some techniques may suffer from a significant time lag, which might affect the timing of the rendering or might otherwise might detract from the user experience.

Therefore, there is a need for image processing methods and closer to real-time rendering methods that might enhance the quality of rendered AR images, or otherwise might improve a user experience.

### SUMMARY

According to some aspects, methods disclosed comprise, at a computing device: determining a pose of a camera for a first image, wherein the first image comprises a plurality of pixels, wherein each pixel in the first image comprises a depth value and a color value, and wherein the first image corresponds to a portion of a 3D model of a scene; obtaining a second image based on the camera pose by projecting the portion of the 3D model in a Field Of View (FOV) of the camera; and obtaining a composite image comprising a plurality of composite pixels based, in part, on the first image and the second image, wherein each composite pixel in a subset of the plurality of composite pixels, is obtained, based, in part, on a corresponding absolute difference between a depth value of a corresponding pixel in the first image and a depth value of a corresponding pixel in the second image.

In another aspect, a device may comprise: a camera comprising a depth sensor to obtain a first image, comprising a plurality of pixels, wherein each pixel in the first image comprises a depth value and a color value, and wherein the first image corresponds to a portion of a 3D model of a scene; and a processor coupled to the camera, wherein the processor is configured to: determine a camera pose for the first image; obtain a second image based on the camera pose by projecting the portion of the 3D model in a Field Of View (FOV) of the camera; and obtain a composite image comprising a plurality of composite pixels based, in part, on the first image and the second image, wherein each composite pixel in a subset of the plurality of composite pixels, is obtained, based, in part, on a corresponding absolute difference between a depth value of a corresponding pixel in the first image and a depth value of a corresponding pixel in the second image.

In another aspect, a device may comprise: imaging means a comprising a depth sensing means, the imaging means to obtain a first image, comprising a plurality of pixels, wherein each pixel in the first image comprises a depth value and a color value, and wherein the first image corresponds to a portion of a 3D model of a scene; and processing means coupled to the imaging means, wherein the processing means comprises: means for determining an imaging means pose for the first image; means for obtaining a second image based on the imaging means pose by projecting the portion of the 3D model in a Field Of View (FOV) of the imaging means; and means for obtaining a composite image comprising a plurality of composite pixels based, in part, on the first image and the second image, wherein each composite pixel in a subset of the plurality of composite pixels, is obtained, based, in part, on a corresponding absolute difference between a depth value of a corresponding pixel in the first image and a depth value of a corresponding pixel in the second image.

Disclosed embodiments also pertain to an article comprising a non-transitory computer readable medium comprising instructions that are executable by a processor to: determine a camera pose for a live first image, wherein the first image comprises a plurality of pixels, wherein each pixel in the first image comprises a depth value and a color value, and wherein the first image corresponds to a portion of a 3D model of a scene; obtain a second image based on the camera pose by projecting the portion of the 3D model into a Field Of View (FOV) of the camera; and obtain a composite image comprising a plurality of composite pixels based, in part, on the first image and the second image, wherein each composite pixel in a subset of the plurality of composite pixels, is obtained, based, at least in part, on a corresponding absolute difference between a depth value of a corresponding pixel in the first image and a depth value of a corresponding pixel in the second image.

Embodiments disclosed also relate to hardware, software, firmware, and program instructions created, stored, accessed, or modified by processors using computer readable media or computer-readable memory. The methods described may be performed on processors and various user equipment. These and other embodiments are further explained below with respect to the following figures. It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

Embodiments of the invention will be described, by way of example only, with reference to the drawings.

FIG. 1 shows a block diagram of exemplary User Equipment (UE) capable of implementing computer vision applications, including augmented reality effects in a manner consistent with certain embodiments presented herein.

FIG. 2 illustrates an application of updates to a displayed image based on a volumetric model with a static and moving object, in accordance with certain embodiments presented herein.

FIG. 3 illustrates an application of shadows to a displayed image based on a volumetric model with a static and moving object, in accordance with certain embodiments presented herein.

FIG. 4 illustrates the time lag for some example volumetric representations are used in AR.

FIG. 5 shows a high-level flowchart illustrating an exemplary method for light estimation and AR rendering in accordance with certain embodiments presented herein.

FIG. 6 shows a flowchart illustrating an exemplary method for light estimation and AR rendering, in accordance with certain embodiments presented herein.

FIG. 7A shows exemplary intensity image captured by camera, in accordance with certain embodiments presented herein.

FIG. 7B shows the depth image associated with the intensity image in FIG. 7A, which contains holes, in accordance with certain embodiments presented herein.

FIG. 7C shows a depth image obtained by applying a hole-filling filter to the depth image in FIG. 7B, in accordance with certain embodiments presented herein.

FIG. 7D shows a depth image obtained by applying an edge filter to the filtered depth image in FIG. 7C, in accordance with certain embodiments presented herein.

FIG. 7E shows a depth image obtained by applying an edge filter to the image in FIG. 7D, in accordance with certain embodiments presented herein.

FIG. 8 illustrates an exemplary visibility computation in geometry buffer(s) G_{RV} in accordance with certain embodiments presented herein.

FIG. 9 shows a schematic block diagram illustrating a server enabled to facilitate AR lighting with dynamic geometry in a manner consistent with, in accordance with certain embodiments presented herein.

FIG. 10 shows a flowchart illustrating an exemplary method for light estimation and AR rendering consistent with certain embodiments presented herein.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

In some embodiments disclosed herein computer vision and image processing techniques are applied to AR lighting models to facilitate dynamic geometry and lighting, while maintaining real-time performance. Consequently, user AR experience may be enhanced. In some embodiments, a 3D volumetric or object space representation of a scene may be used to model static object illumination effects. Further, global illumination for dynamic object illumination effects may be modeled in a computationally efficient manner using a composite image, which may be obtained from: (i) a projected image obtained by projecting the volumetric representation of the scene into the camera's current field of view; or (ii) a current a color+depth (e.g. RGB-D) image, which may be obtained from an RGB-D sensor. The composite image may be used for screen space computations. In some embodiments, the current color+depth image may also be used to update the volumetric model.

Thus, some embodiments disclosed herein facilitate the computation of global light interaction by combining information from three sources in real-time. These sources include: (1) the (static) geometric or volumetric model, which includes information from outside the sensor's current FOV, (2) the (dynamic) geometric model in the sensor's current FOV, and (3) the (dynamic) directional lighting, which may be estimated using probeless photometric registration. In some embodiments, a composite image may be obtained from sources (1) and (2) above using a technique that combines screen space and object space filtering. Techniques based on screen-space global illumination approximation with per-pixel spherical harmonics may be applied to the composite image to render high quality image at a relatively low computational cost.

The term “global illumination” may refer to the modeling of lighting interaction between both (i) objects and other objects and (ii) objects and their environment. Global illumination may include both global direct illumination, where light which comes directly from a light source is modeled, and also global indirect illumination, which models both global direct illumination and other light effects where light rays from the light source affected by other surfaces in the scene. Global indirect illumination may thus consider effects such as reflections, shadows, refraction etc. that may be induced by object and/or the environment on other objects.

In some 3D reconstruction techniques, which may be computationally expensive, a set of digital images are typically processed off-line in batch mode along with other sensory information and a 3D model of an environment may be obtained, typically, after a long processing delay. Thus, practical real time applications that use 3D reconstruction have been hitherto limited. The term “real time” is used to denote processing (e.g. image processing or computer vision processing), which may be completed in a relatively short time period after an input, trigger and/or stimulus. Thus, for example, the results of any “real time” image or computer vision processing may be available to users within a short time period of image capture. In some instances, the processing time lag may not be noticeable and/or may be acceptable to users.

More recently, some real-time 3D reconstruction has gained traction due perhaps to the availability of increased processing power, advanced algorithms, as well as new forms of input data. Users may now obtain feedback on 3D reconstruction in near real-time as captured pictures are processed rapidly by computing devices, including mobile devices, thereby facilitating real-time or near real-time AR applications. AR applications, which may be real-time interactive, typically combine real and virtual images and perform alignment between a captured image and an object in 3-D. Therefore, determining what objects are present in a real image as well as the location of those objects may facilitate effective operation of many AR and/or MR systems and may be used to aid virtual object placement, removal, occlusion and other lighting and visual effects. In computer vision, detection refers to the process of localizing a target object in a captured image frame and computing a camera pose with respect to a frame of reference. Tracking refers to camera pose estimation over a temporal sequence of image frames.

To achieve real-time performance, some techniques typically use simple lighting models which may degrade a user experience in certain instances. For example, one or more of light reflections from objects in the scene, objects shadows, and various other lighting effects may be omitted or modeled in a manner that makes scenes appear artificial. Other techniques limit the application of lighting effects to static objects that are present in a camera's current field of view based on the camera's estimated pose, without regard to the presence of static object elsewhere in the model. Thus, many techniques using simplified lighting models either consider and use only local illumination (e.g., wherein models consider light sources/objects in the camera's field of view), or limit the lighting effects that are considered (e.g. by considering only single reflections off a surface towards the eye). Thus, some techniques that model lighting effects do so using image-space filtering of depth images based on the current field of view and without consideration of the volumetric scene representation or 3D model.

The term “image space” may refer to a 3D scene model derived from a current live depth image captured by a camera and may be limited to the camera's field of view. On the other hand, the term “object space” may refer to a 3D scene model that may represent geometry outside a camera's field of view. For example, a volumetric representation of a scene may include geometry outside a camera's field of view and volumetric reconstruction may be used to integrate live depth images captured by the camera into the volumetric model. The use of certain image-space based techniques may lead to geometric inaccuracies that may lead to scenes appearing artificial. On the other hand, some techniques that use a volumetric model often suffer from significant time lag that impair real time performance and detract from the user experience.

Therefore, some techniques disclosed herein, by way of non-limiting examples, may apply and extend computer vision and image processing techniques and the like to enhance AR lighting models by facilitating dynamic geometry while including information from a volumetric representation and maintaining real-time performance, which may enhance or otherwise affect user AR experience. These and other techniques are further explained below with respect to the figures. It is understood that other aspects will become readily apparent to those skilled in the art from the following detailed description, wherein it is shown and described various aspects by way of illustration. The drawings and detailed description are to be regarded as illustrative in nature and not as restrictive.

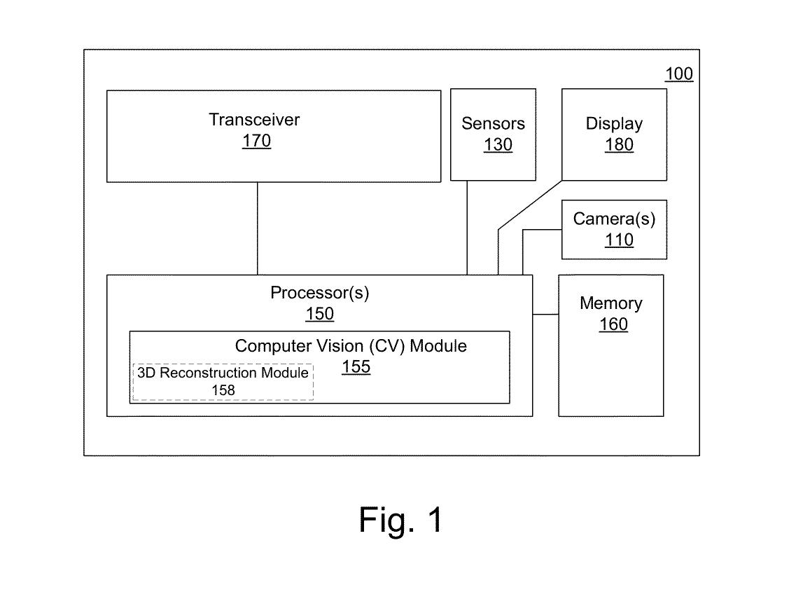

FIG. 1 shows a block diagram of exemplary User Equipment (UE) 100 capable of implementing computer vision applications, including augmented reality effects in a manner consistent with disclosed techniques. In some embodiments, UE 100 may be capable of implementing AR methods based on a 3D model of a scene, which may be obtained in real-time. In some embodiments, the AR methods may be implemented in real time or near real time in a manner consistent with disclosed embodiments.

In FIG. 1, UE 100 may take the form of a mobile station or mobile device such as a cellular phone, mobile phone, or other wireless communication device, a personal communication system (PCS) device, personal navigation device (PND), Personal Information Manager (PIM), or a Personal Digital Assistant (PDA), a laptop, tablet, notebook and/or handheld computer, or other mobile device. In some embodiments, UE 100 may take the form of a wearable computing device, which may include a display device and/or a camera paired to a wearable headset. For example, the headset may include a head mounted display (HMD), which may be used to display live and/or real world images. In some embodiments, the live images may be overlaid with one or more virtual objects. In some embodiments, UE 100 may be capable of receiving wireless communication and/or navigation signals.

In certain instances, a UE may include devices which communicate with a personal navigation device (PND), such as by short-range wireless, infrared, wireline connection, or other connections and/or position-related processing occurs at the device or at the PND. Also, a UE is intended to include all devices, including various wireless communication devices, which are capable of communication with a server, regardless of whether wireless signal reception, assistance data reception, and/or related processing occurs at the device, at a server, or at another device associated with the network. A UE may also refer to any operable combination of the above.

A UE is also intended to include gaming or other devices that may not be configured to connect to a network or to otherwise communicate, either wirelessly or over a wired connection, with another device. For example, UE 100 may omit communication elements and/or networking functionality. For example, all or part of one or more of the techniques described herein may be implemented in a standalone device that may not be configured to connect for wired or wireless networking with another device.

As shown in FIG. 1, an example UE 100 may include one or more cameras or image sensors 110 (hereinafter referred to as “camera(s) 110”), sensor bank or sensors 130, display 140, one or more processor(s) 150 (hereinafter referred to as “processor(s) 150”), memory 160 and/or transceiver 170, which may be operatively coupled to each other and to other functional units (not shown) on UE 100 through connections 120. Connections 120 may comprise buses, lines, fibers, links, etc., or some combination thereof.

Transceiver 170 may, for example, include a transmitter enabled to transmit one or more signals over one or more types of wireless communication networks and a receiver to receive one or more signals transmitted over the one or more types of wireless communication networks. Transceiver 170 may permit communication with wireless networks based on a variety of technologies such as, but not limited to, femtocells, Wi-Fi networks or Wireless Local Area Networks (WLANs), which may be based on the IEEE 802.11 family of standards, Wireless Personal Area Networks (WPANS) such Bluetooth, Near Field Communication (NFC), networks based on the IEEE 802.15x family of standards, etc, and/or Wireless Wide Area Networks (WWANs) such as LTE, WiMAX, etc.

For example, the transceiver 170 may facilitate communication with a WWAN such as a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), WiMax and so on.

A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM, W-CDMA, and LTE are described in documents from an organization known as the “3rd Generation Partnership Project” (3GPP). Cdma2000 is described in documents from a consortium named “3rd Generation Partnership Project 2” (3GPP2). 3GPP and 3GPP2 documents are publicly available. The techniques may also be implemented in conjunction with any combination of WWAN, WLAN and/or WPAN. UE 100 may also include one or more ports for communicating over wired networks. In some embodiments, the transceiver 170 and/or one or more other ports on UE 100 may be omitted. Embodiments disclosed herein may be used in a standalone CV/AR system/device, for example, in a mobile station that does not require communication with another device.

In some embodiments, camera(s) 110 may include front and/or rear-facing cameras, wide-angle cameras, and may also incorporate charge coupled devices (CCD), complementary metal oxide semiconductor (CMOS), and/or various other image sensors. Camera(s) 110, which may be still or video cameras, may capture a series of image frames of an scene and send the captured image frames to processor 150. In one embodiment, images captured by camera(s) 110 may be in a raw uncompressed format and may be compressed prior to being processed by processor(s) 150 and/or stored in memory 160. In some embodiments, image compression may be performed by processor(s) 150 using lossless or lossy compression techniques. In some embodiments, camera(s) 110 may be external and/or housed in a wearable display, which may be operationally coupled to, but housed separately from, processors 150 and/or other functional units in UE 100.

In some embodiments, camera(s) 110 may be color or grayscale cameras, which provide “color information.” Camera(s) 110 may capture images comprising of a series of color images or color image frames. The term “color information” as used herein refers to color and/or grayscale information. In general, as used herein, a color image or color information may be viewed as comprising 1 to N channels, where N is some integer dependent on the color space being used to store the image. For example, an RGB image comprises three channels, with one channel each for Red, Blue and Green information. For “black and white” images, color information may comprise a single channel with pixel intensity or grayscale information.

In some embodiments, camera(s) 110 may include depth sensors, which may provide “depth information”. The term “depth sensor” is used to refer to functional units that may be used to obtain per-pixel depth information independently and/or in conjunction with the capture of color images by camera(s) 110. The depth sensor may capture depth information for a scene in the camera's field of view. Accordingly, each color image frame may be associated with a depth frame, which may provide depth information for objects in the color image frame.

In one embodiment, camera(s) 110 may be stereoscopic and capable of capturing 3D images. For example, a depth sensor may take the form of a passive stereo vision sensor, which may use two or more cameras to obtain depth information for a scene. The pixel coordinates of points common to both cameras in a captured scene may be used along with camera pose information and/or triangulation techniques to obtain per-pixel depth information. In another embodiment, camera(s) 110 may comprise RGBD cameras, which may capture per-pixel depth information when an active depth sensor is enabled in addition to color (RGB) images. As another example, in some embodiments, camera(s) 110 may take the form of a 3D Time Of Flight (3DTOF) camera. In embodiments with 3DTOF camera(s) 110, the depth sensor may take the form of a strobe light coupled to the 3DTOF camera, which may illuminate objects in a scene and reflected light may be captured by a CCD/CMOS or other image sensors. Depth information may be obtained by measuring the time that the light pulses take to travel to the objects and back to the sensor.

Processor(s) 150 may execute software to process image frames captured by camera(s) 110. For example, processor(s) 150 may be capable of processing one or more image frames captured by camera(s) 110 to perform various computer vision and image processing algorithms, camera pose estimation, tracking, running AR applications and/or performing 3D reconstruction of a scene based on an images received from camera(s) 110. The pose of camera 110 refers to the position and orientation of the camera 110 relative to a frame of reference. In some embodiments, camera pose may be determined for 6-Degrees Of Freedom (6DOF), which refers to three translation components (which may be given by X,Y,Z coordinates) and three angular components (e.g. roll, pitch and yaw). In some embodiments, the pose of camera 110 and/or UE 100 may be determined and/or tracked by processor(s) 150 using a visual tracking solution based on image frames captured by camera 110.

Processor(s) 150 may be implemented using a combination of hardware, firmware, and software. Processor(s) 150 may represent one or more circuits configurable to perform at least a portion of a computing procedure or process related to CV including image analysis, 3D reconstruction, tracking, feature extraction from images, feature correspondence between images, modeling, image processing etc and may retrieve instructions and/or data from memory 160. In some embodiments, processor(s) 150 may comprise CV module 155, which may execute or facilitate the execution of various CV applications, such as the exemplary CV applications outlined in the disclosure. CV Module 155 may be implemented using some combination of hardware and software. For example, in one embodiment, CV module 155 may be implemented using software and firmware. In another embodiment, dedicated circuitry, such as Application Specific Integrated Circuits (ASICs), Digital Signal Processors (DSPs), etc. may be used to implement CV module 155. In some embodiments, CV module 155 may include functionality to communicate with one or more other processors and/or other components on UE 100.

In some embodiments, CV module 155 may implement various computer vision and/or image processing methods such as 3D reconstruction, AR, shading, light and geometry estimation, ray casting, image compression and filtering. Ray tracing or casting refers to computationally tracing the path of reflected or transmitted (e.g. refracted) rays through a scene being modeled. In some embodiments, the methods implemented by CV module 155 may be based on camera captured color or grayscale image data and depth information, which may be used to generate estimates of 6DOF pose measurements of the camera. In some embodiments, CV module 155 may include 3D reconstruction module 158, which may use the camera pose and per-pixel depth information to create and/or update a 3D model or representation of the scene.

In some embodiments, the 3D model may take the form of a textured 3D mesh, a volumetric data set, a CAD model etc., which may be used to render the 3D scene being modeled. In one embodiment, the volumetric representation may use an implicit representation of the surface using a 3D truncated signed distance function (TDSF). The 3D TDSF may be represented as a set of regular samples in 3D space. At each sample, the sample value gives the signed distance to the estimated surface. Positive distances denote samples outside the object, and negative distances samples inside the object. In some embodiments, keyframe based Simultaneous Localization and Mapping (SLAM) may be used to obtain a 3D model of the scene. In general, any full 3D volumetric representation method, which covers the whole scene and is not limited to the current field of view (FOV), may be used. CV module 155 may implement computer vision based tracking, model-based tracking, SLAM, etc.

SLAM/Visual SLAM (VSLAM) based techniques may permit the generation of maps of an unknown scene while simultaneously localizing the position of camera 110 and/or DE 110. In VSLAM, images obtained by a camera (such as camera(s) 110) may be used to model an unknown scene with relatively low computational overhead, which may facilitate real-time and/or near real time modeling. In certain instances, SLAM may represent a class of techniques where a map of a scene, such as a map of a scene being modeled by UE 100, may be created while simultaneously tracking the pose of UE 100 relative to that map. Some SLAM techniques may include Visual SLAM (VLSAM) and/or the like, wherein images captured by a single camera, such as camera 110 on UE 100, may be used to create a map of an scene while simultaneously tracking the camera's pose relative to that map. VSLAM may thus involve tracking the 6DOF pose of a camera while also determining the 3-D structure of the surrounding scene. For example, in some embodiments, VSLAM techniques may detect salient feature patches in one or more captured image frames and store the captured imaged frames as keyframes or reference frames. In keyframe based SLAM, the pose of the camera may then be determined, for example, by comparing a currently captured image frame with one or more keyframes.

All or part of memory 160 may be co-located (e.g., on the same die) with processors 150 and/or located external to processors 150. Processor(s) 150 may be implemented using one or more application specific integrated circuits (ASICs), central and/or graphical processing units (CPUs and/or GPUs), digital signal processors (DSPs), digital signal processing devices (DSPDs), programmable logic devices (PLDs), field programmable gate arrays (FPGAs), controllers, micro-controllers, microprocessors, embedded processor cores, electronic devices, other electronic units designed to perform the functions described herein, or a combination thereof, just to name a few examples.

Memory 160 may represent any type of long term, short term, volatile, nonvolatile, or other memory and is not to be limited to any particular type of memory or number of memories, or type of physical media upon which memory is stored. In some embodiments, memory 160 may hold code (e.g., instructions that may be executed by one or more processors) to facilitate various CV and/or image processing methods including image analysis, tracking, feature detection/extraction, feature correspondence determination, modeling, 3D reconstruction, AR applications and other tasks performed by processor 150. For example, memory 160 may hold data, captured still images, 3D models, depth information, video frames, program results, as well as data provided by various sensors, just to name a few examples. In general, memory 160 may represent any data storage mechanism. Memory 160 may include, for example, a primary memory and/or a secondary memory. Primary memory may include, for example, a random access memory, read only memory, etc. While illustrated in FIG. 1 as being separate from processors 150, it should be understood that all or part of a primary memory may be provided within or otherwise co-located and/or coupled to processors 150.

Secondary memory may include, for example, the same or similar type of memory as primary memory and/or one or more data storage devices or systems, such as, for example, flash/USB memory drives, memory card drives, disk drives, optical disc drives, tape drives, solid state drives, hybrid drives etc. In certain implementations, secondary memory may be operatively receptive of, or otherwise configurable to couple to a non-transitory computer-readable medium in a removable media drive (not shown) coupled to UE 100. In some embodiments, non-transitory computer readable medium may form part of memory 160 and/or processor 150.

In some embodiments, UE 100 may comprise a variety of other sensors 130 such as one or more of ambient light sensors, microphones, acoustic sensors, ultrasonic sensors, etc. In certain example implementations, sensors 130 may include all or part of an Inertial Measurement Unit (IMU), which may comprise one or more gyroscopes, one or more accelerometers, and/or magnetometer(s). The IMU may provide velocity, orientation, and/or other position related information to processor 150. In some embodiments, an IMU or the like may output measured information in synchronization with the capture of each image frame by cameras 110. In some embodiments, the output of an IMU or the like may be used in part by processor(s) 150 to determine, correct, and/or otherwise affect the estimated pose a pose of camera 110 and/or UE 100. Further, in some embodiments, images captured by camera(s) 110 may also be used to recalibrate or perform bias adjustments for the IMU.

Further, UE 100 may include a screen or display 180 capable of rendering color images, including 3D images. In some embodiments, UE 100 may comprise ports to permit the display of the 3D reconstructed images through a separate monitor or display coupled to UE 100. In some embodiments, the display and/or UE 100 may take the form of a wearable device. In some embodiments, display 180 may be used to display live images captured by camera(s) 110, Augmented Reality (AR) images, all or part of a Graphical User Interface (GUI), a program output, etc. In some embodiments, display 180 may comprise and/or be housed with a touchscreen to permit users to input data via some combination of virtual keyboards, icons, menus, or other GUIs, user gestures and/or input devices such as a stylus and other input devices. In some embodiments, display 180 may be implemented using a Liquid Crystal Display (LCD) display or a Light Emitting Diode (LED) display, such as an Organic LED (OLED) display. In other embodiments, display 180 may be a wearable display, which may be operationally coupled to, but housed separately from, other functional units in UE 100. In some embodiments, UE 100 may comprise one or more ports to permit the display of images through a separate monitor coupled to UE 100.

Not all modules comprised in UE 100 have been shown in FIG. 1. Exemplary user device 100 may also be modified in various ways in a manner consistent with the disclosure, such as, by adding, combining, or omitting one or more of the functional blocks shown. For example, in some configurations, UE 100 may not include Transceiver 170. In some embodiments, UE 100 may additionally comprise a Satellite Positioning System (SPS) unit (not shown), which may be used to provide location information to UE 100. In some embodiments, portions of UE 100 may take the form of one or more chipsets, and/or the like.

Some techniques for lighting estimation in AR make simplifying assumptions about dynamic environmental aspects when performing lighting simulation. For example, many techniques consider and use only local illumination (e.g., wherein models consider light sources reflected once off a surface towards the eye). These assumptions severely restrict applicability of the lighting techniques to real-world AR applications. Thus, such techniques may be: (i) limited to small scenes and/or (ii) require a priori knowledge of scene geometry (e.g. by scanning or other advance preparation of the scene) which may be impractical. For example, when creating AR lighting demonstrations using some techniques, small scenes (e.g. a flat table with a few objects) may be used along with marker tracking to avoid 3D reconstruction. The small scene size often permits computationally expensive rendering techniques such as recursive ray tracing to be applied instead of reconstruction. However, even with simplifying assumptions, recursive ray tracing and similar computationally expensive techniques may be infeasible even for some medium-size or less detailed/complex scenes. Some techniques may also partition a scene into a “near” (small) scene and a “far” scene. Here, for example, the near scene may be observed by the user's camera, while light sources (such as ceiling lights or even the sun seen through a window) may be assumed to be contained in the far scene, which is not explicitly modeled. Consequently, such techniques essentially assume that illumination is static and directional. Thus, the lighting simulation is limited by the lack of far scene geometry.

When dynamic lighting effects are desired, some techniques for lighting estimation in AR often use invasive lightprobes. The lighting estimation may involve the use of passive light probes, which may be specular and/or diffuse, or active such as a fish eye camera, which directly measures real world lighting. In lighting estimation for AR, a lightprobe is placed in the scene to directly capture the directional illumination, which leads to several undesirable consequences (such as scene clutter, additional scene preparation etc.) on account of the invasive nature of lightprobes. Further, active lightprobes may require additional electronics, power, wiring and computational effort. Finally, a lightprobe can only cover illumination for a single position, which may not be enough even for a small scene. With the advent of depth sensors in cameras both color (e.g. RGB) and depth (D) information may be obtained. Therefore, some techniques have been extended to model scenes without the use of lightprobes. However, some of these techniques continue to be limited by assumptions of static geometry and static illumination, while also requiring careful a priori preparation. RGB-D sensors have also been used in the computation of global illumination in dynamic scenes. However, these approaches have been limited to scene geometry based on: (i) the current camera field of view (i.e. at the moment of image capture) and (ii) purely virtual light sources. Some techniques to model non-virtual light sources continue to require the use of lightprobes with the attendant disadvantages outlined above.

Thus, certain techniques for lighting estimation in AR suffer from a variety of drawbacks that limit applicability and/or detract from user experience. Accordingly, some techniques presented herein may facilitate computationally efficient lighting estimation for AR with dynamic scene geometry.

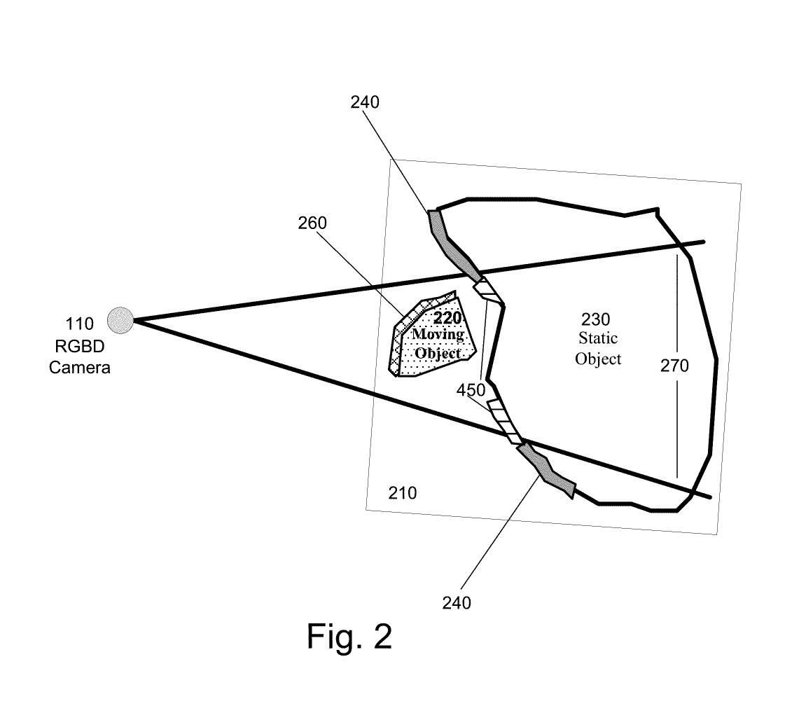

FIG. 2 illustrates the application of updates to a displayed image based on a volumetric model with a static and moving object. As shown in FIG. 2, a volumetric representation 210 of a scene being modeled may be created in real time based on color images with depth information (e.g. RGBD information).

For example, volumetric representation 210 may be created incrementally from RGBD images and represented, for example, using TDSFs. In one embodiment, a live camera pose may be determined (e.g. by using VSLAM based techniques) for consecutive depth frames captured by camera(s) 110 and, a difference image may be computed as the difference between the live depth image and stored volumetric representation 210 projected into the current FOV based on the camera pose. The difference image may indicate new information in the live depth image. For example, the new depth information may correspond to features that were imaged for the first time. Based on the camera pose, new information in the depth frame may be merged incrementally into the 3D reconstruction using the volumetric TSDF to obtain an updated volumetric TDSF representation that includes updated depth information in region 450.

Further, as shown in FIG. 2, for a scene with dynamic geometry with moving real object 220 in FOV 270 of RGBD camera 110 and large static object 230 partially in FOV 270, in general, illumination computations may use depth information for points in region 260 from the live depth frame, updated depth information for points in region 250 from the volumetric TDSF representation, and pre-existing depth information for points in region 440 from the volumetric TDSF representation (which may include depth information for points from outside FOV 470) to render an AR image. For example, in some embodiments, a composite image may be obtained from the volumetric model (which may include information from outside the sensor's current FOV), the dynamic geometric model (from the sensor's current FOV) using a technique that combines screen space and object space filtering. In some embodiments, the composite image, which includes information from both the volumetric representation and current image, may further be used in conjunction with dynamic geometry to compute global light interaction while maintaining real-time performance. For example, techniques based on screen-space global illumination approximation with per-pixel spherical harmonics may be applied to the composite image to render high quality image at a relatively low computational cost.

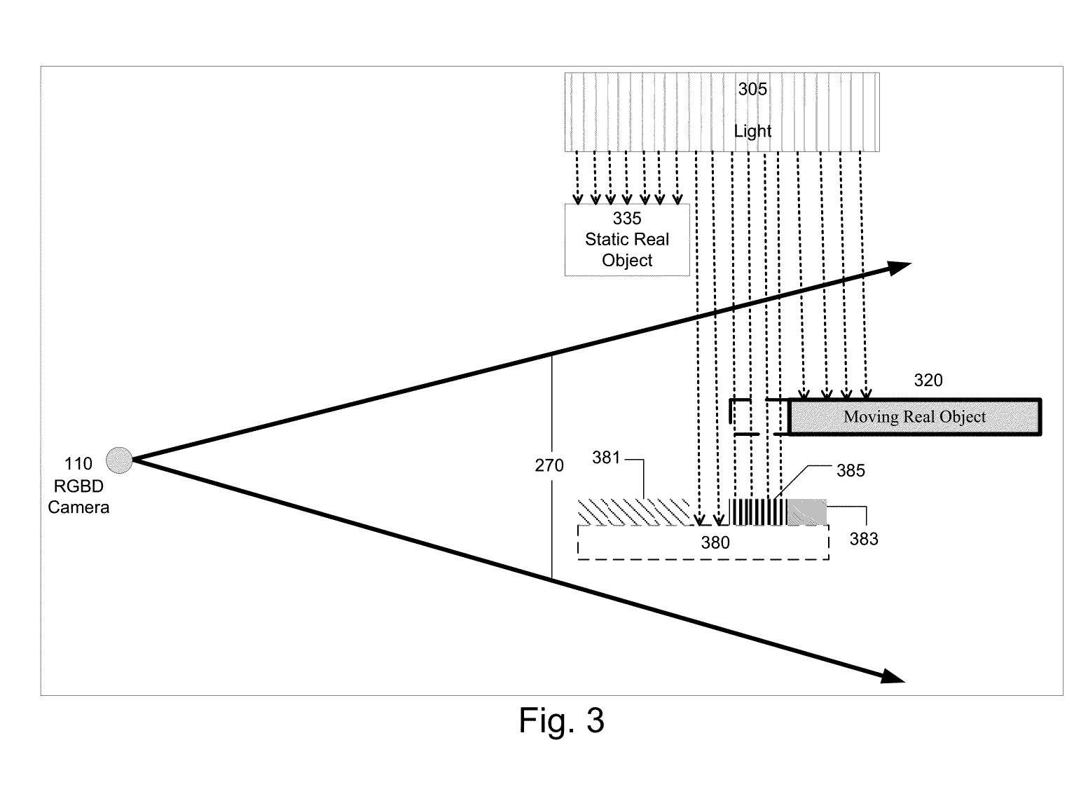

FIG. 3 illustrates the application of shadows to a displayed image based on a volumetric model with a static and moving object. FIG. 3 shows light source 305. In FIG. 3, static real object 335 outside FOV 270 of RGBD camera 110 may cast shadow 381 on virtual object 580. Similarly, moving real object 320 within FOV 470 of camera 110 may initially cast shadow (shown as shaded area) 383, and later cast shadow (shown as striped area) 385 over virtual object 380. When certain image-space based techniques are used, modeling is limited to consideration of current FOV 270. Therefore, some image-space techniques fail to account for the effects of static object 335 outside FOV 270 which may detract from image realism at times. Further, in techniques based on some volumetric representations, if real moving object 220 is initially outside FOV 270 and quickly moved in, then a computational delay in obtaining an updated volumetric TDSF representation may result in a significant time lag that may impact real-time performance and/or possibly resulting in the creation of artifacts.

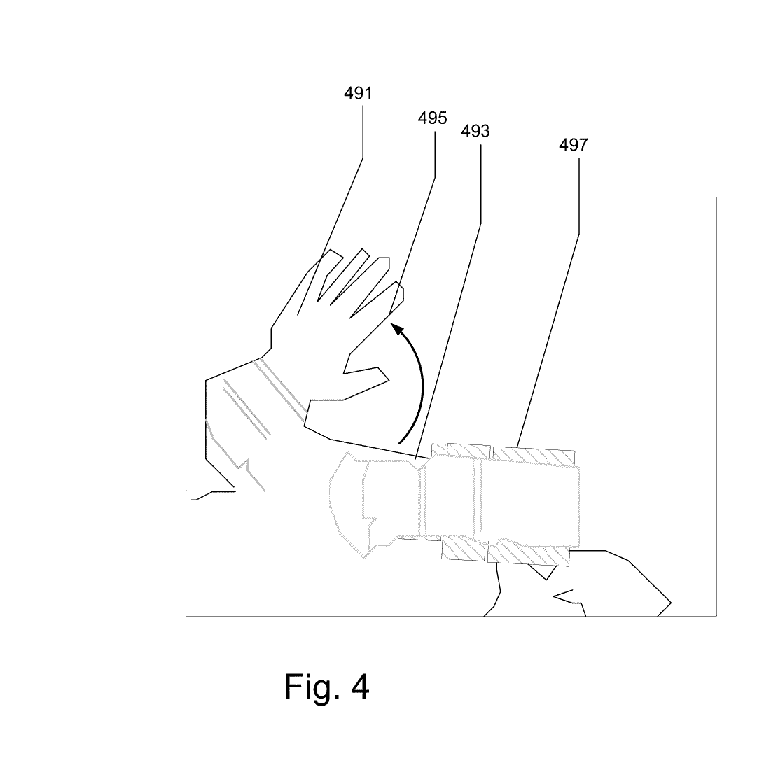

FIG. 4 illustrates an example showing effects that may occur with image-space based techniques based on the use of volumetric representations. As seen in FIG. 4, object 491 (a hand) at a first position 493 has moved to position 495 as indicated by the arrow. However, because of the computation delay in obtaining updated volumetric TDSF representation, the volumetric data may continue to show object 491 at position 493. Accordingly, when some volumetric representations are used, one or more virtual objects 497 may continue to be shown incorrectly as being occluded by object 491 at position 493.

Therefore, some embodiments disclosed herein apply and extend computer vision and image processing techniques to enhance AR lighting models by facilitating dynamic geometry and lighting, while maintaining real-time performance, which may enhance user experience. Embodiments disclosed herein may use a 3D volumetric representation of a scene to model static object illumination effects. Further, in some embodiments, global illumination for dynamic object illumination effects may be modeled in a computationally efficient manner using a 2.5D depth image, which is limited to the current FOV. The term 2.5D depth image refers to a projection of a 3D image representation onto a surface, such as a plane.

For example, in some embodiments, a color+depth (e.g. RGB-D) image, which may be obtained from an RGB-D sensor, may be used as input and optimized for screen-space computations. Disclosed embodiments facilitate the computation of global light interaction by combining information from three sources in real-time. These sources include: (1) the (dynamic) geometric model in the sensor FOV, (2) the (static) geometric model outside the sensor FOV, and (3) the (dynamic) directional lighting, which can be estimated using probeless photometric registration. In some embodiments, a composite image may be obtained from sources (1) and (2) above using disclosed techniques that combine screen space and object space filtering. Techniques based on screen-space global illumination approximation with per-pixel spherical harmonics may be applied to the composite image to render high quality images at a relatively low computational cost. In addition, a reconstructed global model of the scene may be updated based on new information in the input image.

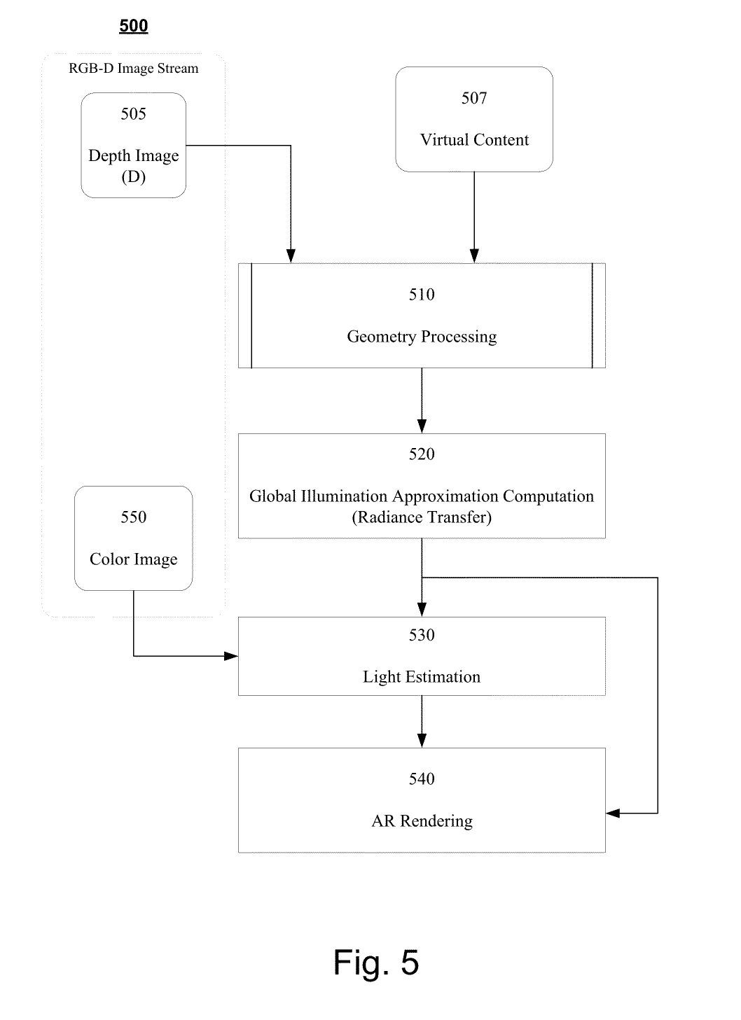

FIG. 5 shows a high-level flowchart illustrating exemplary method 500 for light estimation and AR rendering consistent with disclosed embodiments. The steps shown in method 500 are merely exemplary and the functions performed in the steps and/or the order of execution may be altered in a manner consistent with disclosed embodiments. In some embodiments, a live color+depth (e.g. RGB-D) image stream (shown as color image (e.g. RGB) 550 and depth image (D) 505 in FIG. 5) may be obtained and used as input for geometry processing module 510. In some embodiments, geometry processing module 510 may estimate the camera pose and perform 3D reconstruction based on depth image 505 and virtual content 507. In some embodiments, the 3D reconstruction may take the form of a volumetric representation, which may include static and/or gradually updating geometry of the scene being modeled. Further, in some embodiments, a depth map may be obtained based, in part, on current depth image 505 and by projecting the reconstructed volume into the camera's field of view (FOV) based on the current camera pose.

In some embodiments, the geometry information and depth map may be input to Global Illumination Approximation Computation module 520, which may compute the radiance transfer based on Screen Space Directional Occlusion (SSDO). SSDO is described, for example, in “Approximating Dynamic Global Illumination in Image Space,” ACM SIGGRAPH Symposium on Interactive 3D Graphics and Games, (i3D) 2009, p. 75-82. Global illumination methods compute the shading at a surface point based on the entire scene. Radiance transfer (RT) refers to the computation of illumination/shading at a surface point. SSDO facilitates approximations of real-time global illumination effects such as inter-reflections using screen space or image space. In SSDO, global illumination computations are performed based on surfaces visible to the end user in an image frame. A point x may be determined to be in shadow if a point s on a surface is closer to the projection plane than x.

SSDO techniques avoid the use of computationally expensive ray-tracing steps to determine visibility. However, in some instances, certain SSDO techniques may miss thin occluding objects in the scene. Further, because of the approximations used, some SSDO techniques may not accurately determine visibility for rays directed away from the camera. In some embodiments, to improve the quality of the visibility testing and to enable coherent shadowing between visible reconstructed geometry and non-visible reconstructed geometry, shadow geometry buffers covering the entire workspace or scene being modeled may be determined. Accordingly, in some embodiments, occlusion computations to determine visible surfaces in an image frame may be enhanced by additional shadow geometry buffers that cover the entire workspace. In some embodiments, the shadow geometry buffers and geometry computations may be determined based on the dominant light direction. For example, the SSDO approximations may be projected into Spherical Harmonics (SH) and a dominant light direction may be extracted from SH coefficients. The final per pixel RT may be represented using SH coefficients, which may store RT in a compressed form.

The SH coefficients are input to Light Estimation (LE) module 530. Light estimation techniques such as those that have been described in U.S. Patent Publication No. 2013/0271625 entitled “Photometric Registration from Arbitrary Geometry for Augmented Reality,” which is assigned to the assignee hereof, may be used or adapted for use in step 530. In some embodiments, LE module 530 may estimate distant environment lights. In some embodiments, LE module 530 may be provided with parameters, which may pertain to one or more of light color or surface reflectance. For example, based on the provided parameters, LE module may determine that the light color is white and that the surface represented by the reconstructed geometry is a diffuse reflective surface.

In some embodiments, AR Rendering module 540 may compute the AR image to be rendered using differential rendering techniques, and/or other like techniques. In some embodiments, method 500 may be performed by UE 100. Differential rendering techniques may, for example, be used in AR to apply virtual lighting effects to the real world and real world lighting effects to the virtual. In differential rendering, radiance and global illumination information for the scene being modeled are used to add new virtual objects to the modeled scene. Specifically, the scene is partitioned into: a local scene around the virtual objects, where reflectance is modeled; and a distant scene, which is assumed to be unaffected by the local virtual objects so that reflectance may be ignored. Thus, geometry and surface properties of the local scene may be used to determine the interaction of light with virtual objects for rendering purposes.

In some embodiments, method 500 may be performed by processor(s) 150 using CV module 155 and/or 3D Reconstruction Module 158. In some embodiments, method 500 may be performed by some combination of hardware, software and/or firmware.

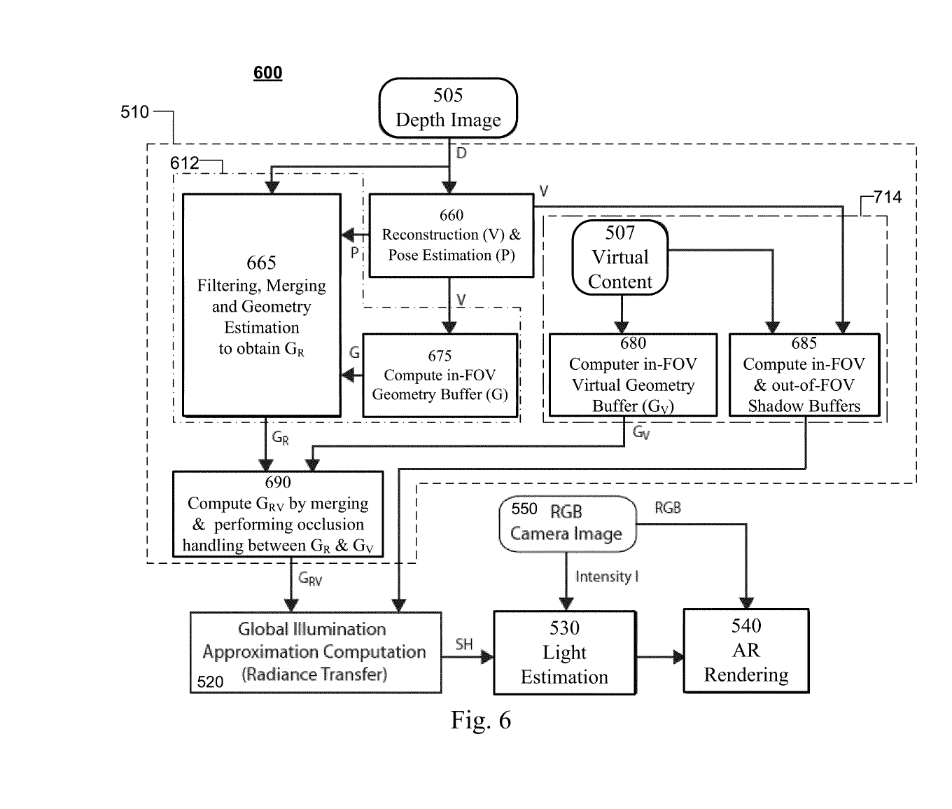

FIG. 6 shows a flowchart illustrating a method 600 for light estimation and AR rendering. In some embodiments, method 600 may be applied to determine AR lighting in scenes with dynamic geometry in a manner consistent with disclosed embodiments. In some embodiments, steps 660, 665, 675, 680, 685 and 690 may form part of geometry processing module 510. The steps shown in method 600 are merely exemplary and the functions performed in the steps and/or the order of execution may be altered in a manner consistent with disclosed embodiments.

In step 660, reconstruction and pose estimation may be performed based on depth image 505. For example, a depth image 505 may be received from a depth camera, depth sensor coupled to a color camera, a stereo camera and/or obtained from a depth estimation algorithm, just to name a few examples. By way of example, VSLAM or other like techniques may be used to estimate a depth image when a monocular camera is used.

Further, in step 660, a 3D model of a scene represented by volume V may be reconstructed and a pose P may be computed for the camera (e.g. camera 110). Pose P may represent a 6DOF pose, for example, when camera motion is unconstrained relative to the scene being modeled. Various incremental reconstruction techniques that integrate the V over time based on the captured depth information D may be used. As one example, new information in depth image 505 may be integrated into volume V. As more depth information from additional depth images 505 is integrated into volume V over time, volume V becomes more complete. Thus, incremental reconstruction techniques may yield accurate results over longer times. For example, in embodiments, where V is represented using a TSDF, a live camera pose P may be determined for each depth image 505 received from camera(s) 110. Based on the camera pose, new information in the depth image 505 may be fused incrementally into volume V to obtain an updated volumetric TDSF representation. The volumetric TDSF representation V may hold the static and gradually updating geometry. Relative to a current depth image 505 (which may have noise, holes and other inaccuracies), volumetric representation V may have more accurate information for static portions of the scene being modeled.

The term“world space” may refer to 3D points relative to a fixed coordinate center in the real world. In embodiments, where 3D points are obtained by the depth sensor in “projective space” relative to the camera coordinate system, the “projective space” points may be converted to “world space”. The volumetric reconstruction represents the geometry and hence all 3D points in “world space”. In some instances, the depth information from the depth sensor may comprise 3D points in “projective space”. From the pose P of camera 110 relative to the fixed coordinate center in the real world, the 3D points in “projective space” may be transformed into 3D points in “world space”.

In step 675 real world geometry buffer G, for the portion of the scene being modeled in the field of view of the camera may be computed. The “real world” geometry buffer may comprise a set of 3D points (in a coordinate frame modeled by volume V), which locate an object in the scene being modeled. In some embodiments, real world geometry buffer G may be computed from the reconstruction volume V in the FOV of camera 110. For example, real world geometry buffer G may be obtained by projecting the reconstruction volume into the FOV of camera 110 based on camera pose P computed in step 660. In some embodiments, the real world geometry buffer (G) may take the form of a camera image aligned 2D buffer or a camera plane aligned 2D buffer. In some embodiments, real world geometry buffer may be used to represent a 3D position V(x, y, z) and the surface normal vector N(nₓ, n_{y}, n_{z}) for each pixel. In some embodiments, the size of the real world geometry buffer, which is based on depth image 505, may be set based on depth sensor resolution.

The term “real world” geometry may refer to geometry originating from a 3D model and/or reconstruction of the real world, such as volumetric reconstruction V. Thus real world data may be a digital representation of a reconstruction and/or measurement from the actual real world in the processing pipeline. Conversely, a “virtual world” or “virtual content” or a “virtual model” refers to data which is added to the real world, for example, in the context of AR, the virtual model may include (virtual) augmentation content.

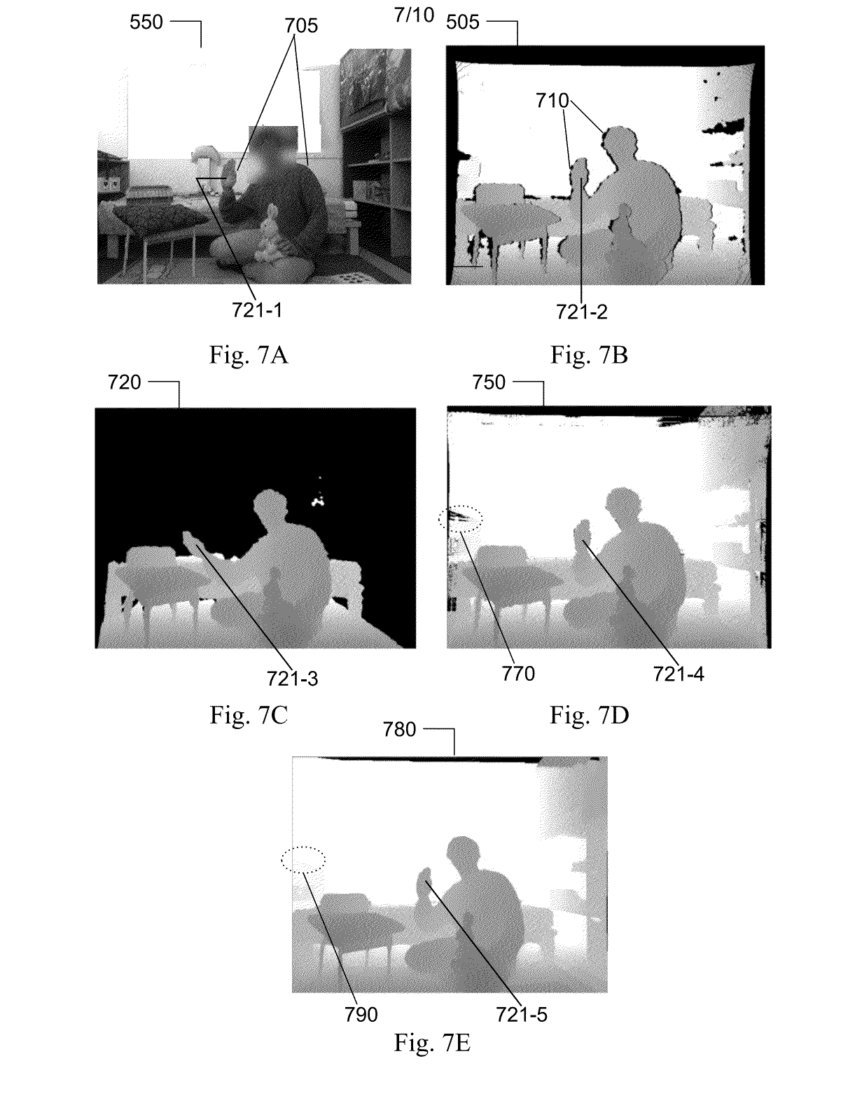

In step 665, filtering, merging and geometry estimation may be performed. For example, filtering and merging of information in the live image and volumetric representations may be performed based on the camera pose P. Further, geometry estimation may be performed based on the live camera image and inputs received from steps 660 and 675. In some embodiments, the raw depth-image may optionally be filtered and merged with information in the volumetric representation, based on the camera pose, e.g., to remove holes, smooth edges, remove noise, etc. In some embodiments, the filtering and merging may be performed for the raw depth image 505, and geometry estimation may be performed on the filtered and merged image based on depth values and on a 6DOF camera pose P computed in step 660. In some embodiments, the merging of information in the live image and the volumetric representation may occur as a consequence of the operation of the filter. The operation of the filter is described further below in conjunction with FIGS. 7A-7E.

In many instances, depth images from handheld devices with depth sensors may be noisy. For example, depth image 505 may have “holes” arising from missing depth measurements in the image. Therefore, in some embodiments, filtering may be applied to depth image 505, for example, in step 665, to facilitate high quality AR compositing and rendering.

FIGS. 7A-7E show a sequence of images (projected into the viewpoint of camera 110 based on camera pose P) including exemplary color image 550, depth image 505 and images at various stages of the filtering. In some embodiments, various filters (not shown) may be applied. For example, a first filter (not shown) may be applied to input depth image 505 and a second filter (not shown) may be applied to the output of the first filter and so on.

In some embodiments, filters may be applied in a series of passes over depth image 505. In some embodiments, a modified median filter (not shown) which uses both depth and color information to fill holes and smooth the depth image may be used.

First, for a color image (I) 550, a filter may be defined generally as

Ω_{I}(p)={q_{I}εΩₖ(p),|I(p)−I(q_{I})|<λ_{I}} (1)

The filter in equation (1) above ensures that object boundaries are not crossed when performing filling and smoothing operations for a pixel. Ωₖ(p) is a square neighborhood around pixel p with radius k and I(p) is the intensity of pixel p in color image 550. The filter in equation (1) above ensures that the absolute value of the difference in intensities between a pixel p and the intensities of pixels in some square neighborhood of radius k around pixel p fall below threshold λ₁. In other words, if the intensity of a pixel q_{I} in a square neighborhood of radius k around pixel p is above threshold λ₁, that pixel is assumed to belong to another object. The square neighborhood of radius k around a pixel p is also referred to as the support region for pixel p. The filter above may be generalized or broadened to other polygons or shapes and pixel distances. For example, the square neighborhood may represent one type of polygon, and the square radius may represent the pixel distance for the square neighborhood. The term pixel distance may refer to the number of pixels separating a pixel from another given pixel.

By preventing or decreasing the likelihood that object boundaries will be crossed, the filter above may decrease the likelihood of smoothing between pixels that belonging to different objects. For example, the filter may decrease the likelihood that smoothing will occur between distinct but proximate objects. For example, if a depth image fails to discriminate between certain distinct but proximate objects, intensity may help to distinguish object boundaries. Accordingly, in some embodiments, the radius k of the support region and threshold λ₁ may be set appropriately to facilitate discrimination between image objects. In this example, threshold λ_{I} determines a cutoff for including neighboring pixels q based on the absolute intensity difference between the neighboring pixel and the center pixel.

Next, a subset of pixels from Ω_{D}(p) from depth image D 505, which are within an absolute depth difference of a threshold λ_{D} may be determined. The subset of pixels may be denoted as Ω_{D}(p)⊂Ω_{I}(p).

Ω_{D}(p)={q_{D}εΩ_{D}(p),|D(p)−Dᵥₒₗᵤₘₑ(q_{D})|<λ_{D}} (2)

where Ωₖ(p), in this example, is a square neighborhood around pixel p with radius k, D(p) is the depth value at pixel p in depth image 505 and Dᵥₒₗᵤₘₑ(q_{D}) is the depth value at pixel (q_{D}) extracted from the volume reconstruction. In certain instances, pixels with missing depth measurements (i.e. “holes”) may be designated as invalid and excluded from Ωₖ(p).

The effect of the above filter is that, in this example, a pixel as represented in the depth image may be replaced/represented by a median of the depth of a subset of pixels in the support region with: (i) a valid depth measurement and which have similar intensity or, (ii) if a majority of inspected pixels in the support region are close in depth (differ by less than λ_{D}) to the depth value of a corresponding pixel in the volumetric representation, then the depth value from the volume Dᵥₒₗᵤₘₑ(q_{D}) may be used to replace the depth map input. Otherwise, the median depth of the support region may be used. Thus, by appropriate selection of thresholds λ_{I} and λ_{D}, the filter may, for example, be applied to depth image D 505 to fill-in holes and smooth the depth image while respecting boundaries indicated by the intensity gradients in color image 550.

Thus, the result D_{P1}(p) of a first pass P1 of the filter may be computed using one or more of the following four cases:

D_{P1}(p)=D(p), if D(p)≠0 and |D(p)−Dᵥₒₗᵤₘₑ(p)|>λ_{D}, else

D_{P1}(p)=Dᵥₒₗᵤₘₑ(p) if D(p)≠0 and |D(p)−Dᵥₒₗᵤₘₑ(p)|<λ_{D}, else

D_{P1}(p)=Dᵥₒₗᵤₘₑ(p) if ∥Ω_{D}(p)∥>∥Ω_{I}(p)/q∥, else

D_{P1}(p)=median({D(q):qεΩ_{I}(p)}), otherwise. (3)

where ∥Ω_{D}(p)∥ is a count of the number of pixels in the support region of a pixel p in the depth image, ∥Ω_{I}(p)∥ is the number of pixels in the support region of corresponding pixel p in the color image, and w>0 is a weight. For example, if w=2, then a pixel from the reconstruction may be selected whenever

∥Ω_{D}(p)∥>∥Ω_{I}(p)/2∥ (4)

Accordingly, for w=2 and a pixel p, a corresponding pixel from the reconstruction Dᵥₒₗᵤₘₑ(p) may be selected by: (i) obtaining a count Q_{I} of pixels (q_{I}) in a support region of pixel p for which the condition |I(p)−I(q_{I})|<λ_{I}, is true; (ii) obtaining a count Q_{D} of pixels counting pixels (q_{D}) in a subset of the support region for which the condition |D(p)−Dᵥₒₗᵤₘₑ(q_{D})|<λ_{D} is true; and (iii) selecting

$${D}_{volume} ( p ) , if {Q}_{D} > \frac{{Q}_{I}}{2} .$$

In general, the weight w may be varied to favor selection of pixels from the current depth image 505, or pixels from the reconstruction V.

By appropriately selecting values of thresholds λ_{I} and λ_{D}, and/or the weight w, the filtering process may be used to favor selection of pixels from the current depth image 505 or the volumetric reconstruction V. For example, a low value of threshold λ_{D} in equation (3) would favor selection of pixels from the current depth image 505, while a high value of threshold λ_{D} in equation (3) would favor selection of pixels from the volumetric reconstruction V.

In some embodiments, the filter in equation (1) may be applied during a first pass P1 only to missing pixels using a large radius k=k₁ to fill holes. Next, during a second pass P2, a smaller radius k=k₂ may be used and the filter may be applied, for example, to all pixels to correct registration errors between the depth image 505 and color image 550. Further, the second pass P2 of the filter may result in greater alignment between edges in depth image 505 and edges in color image 550. In addition, during a third pass P3 of the filter, a small radius k=k₃ may be used, intensity difference thresholding may be disabled (λ_{I} may be set to ∞) to remove noise. The radiuses k₁, k₂ and k₃ may be selected, for example, based on characteristics of the depth and image sensors and/or system parameters such as the quality of rendering desired and/or response time.

FIG. 7A shows exemplary color image 550 captured by camera 110, while FIG. 7B shows the associated depth image 505, which contains holes 710. Holes 710 may be caused by one or more of surfaces at oblique angles, reflective surfaces, and/or objects outside the depth range of the sensor. Further, depth image 505 may not be well-aligned relative to color image 550 and may also contain noise. For example, the edges of hand 721-2 (in FIG. 7B) may not be well-aligned with edges of hand 721-1 (in FIG. 7A).

FIG. 7C shows depth image 720 obtained from the volumetric reconstruction. The depth image 720 may not be aligned to depth image of 505. The depth image in FIG. 7C may contain misalignments. For example, the hand 721-3 (in FIG. 7C) may exhibit misalignment relative to hand 721-1 (in FIG. 7A) in color image 550 and relative to hand 721-2 (in FIG. 7B) in depth image 505.

FIG. 7D shows depth image 750 obtained by filtering and merging the depth image 505 with the depth image 720 from the volume reconstruction, for example, by application of a first and second pass of the filter(s) as described above. In the merged image misalignments may be corrected. For example, in merged depth image 750, the misalignment of hand 721 has been corrected. In merged depth image 750, hand 721-4 (in FIG. 7D) is more closely aligned to hand 721-1 (in FIG. 7A). However, FIG. 7D may contain noise 770 (indicated by the artifacts within the dashed oval),

FIG. 7E shows depth image 780, which may be obtained, for example, by applying a third pass (e.g. noise) of the filter described above, to image 750. In FIG. 7E, locations 790 in depth image 780 correspond to the locations of noise 770 in depth image 750. As shown in FIG. 7E, in image 780, noise has been removed in region 790 as a consequence of applying the filter. The end result image 780 (FIG. 7E) is a smoothed and filled depth image which better matches the contours in the color image 550. For example, hand 721-5 (in FIG. 7E) may exhibit closer alignment with hand 721-1 (in FIG. 7A).

Referring to FIG. 6, buffer G_{R} may be obtained (e.g. after step 665) based on the merging of the depth image 505 with information from the volumetric representation, for example, by application of the filter, as described above. As more of the scene is imaged, the geometry buffer G, which is based on the volumetric reconstruction V, may be smoother and more accurate than a geometry buffer produced solely from the current depth image 505. However, geometry buffer G may also have missing parts or errors caused by dynamic scene changes that occurred subsequent to the most recent volumetric update. Therefore, in some embodiments disclosed, in step 665, filtering may be used to merge information in a geometry buffer obtained from the depth image 505 with geometry buffer G to obtain composite geometry buffer G_{R}. Accordingly, in some embodiments, as a consequence of the compositing, in the merged buffer G_{R}, pixels derived from the depth image 505 may be used in areas where the scene has changed, while pixels derived from G may be used elsewhere in the buffer. As outlined above, in the composite buffer, the merging of pixels may be based on the values of w, λ_{I} and λ_{D}.

As outlined above, in some embodiments, the thresholds λ_{I} and λ_{D} may be selected based on the noise characteristics of a geometric buffer based on the live image and/or geometry buffer G. With some depth sensors, noise increases with depth. Therefore, noise may be modeled (based on depth sensor characteristics) as a function of depth measured by the depth sensor (in instances where the noise is depth dependent). Thus, for depth sensors where noise is depth dependent, in some embodiments, the noise characteristics of a geometry buffer may be estimated based on (i) the number of samples used to produce the geometry buffer and (ii) the depths of the samples. The noise model may yield a per-pixel noise estimate for the geometry buffers. The per pixel noise estimate may then be used, in these cases, to determine a per-pixel threshold to ensure some confidence level in the measurement. For example, a 95% confidence interval may be used. Accordingly, in some embodiments, λ_{D} may vary across the image based on pixel depth.

In some embodiments, steps 665 and 675 may form part of a real geometry processing engine 612, which may perform geometry processing relating to real world objects. Further, steps 680 and 685 may form part of a virtual processing engine 614, which may perform geometry processing relating to virtual objects. Accordingly, in some embodiments, geometry engine 610 may include both real geometry processing engine 612 and virtual geometry processing engine 614.

In step 680, the virtual geometry buffer G_{V} may be computed from the virtual content 507 in the FOV based on the camera pose P. For example, the virtual geometry buffer G_{V} may comprise one or more virtual objects in the FOV that may be used to augment the live image. In some embodiments, virtual content 507 may be created digitally, at least in part, in a preprocessing step. In some embodiments, the virtual content may be maintained separately. In some embodiments, the virtual content may be represented by any appropriate 3D representation, for example, as a set of 3D points describing a triangle mesh and texture maps.

In step 685, shadow maps or shadow buffers both inside and outside the FOV may be determined from the updated real world reconstruction volume V and the virtual geometry buffer G_{V} and/or virtual content 507. In some embodiments, by determining shadow maps from the reconstructed volume, occlusion data from outside the FOV may also be obtained. Thus, shadows may be determined from objects which are not currently visible in the FOV.

In step 690, a combined buffer G_{RV} may be obtained by merging and performing occlusion handling based on the real world geometry buffer G_{R} and virtual world geometry buffer G_{V}. For example, to determine occlusions, the real world geometry buffer G_{R} and virtual world geometry buffer G_{V} may be merged into combined buffer G_{RV}. To determine occlusions, virtual content may be merged into real world content so that: (i) real objects occlude any virtual objects that are behind the real objects; and (ii) virtual objects occlude real objects that are behind the virtual objects.

In some embodiments, differential rendering techniques may be used to compute occlusions. For example, two light evaluations may be computed and occlusions determined. In some embodiments, the light evaluations may include occlusion computation. For example, in the first light evaluation, the “real world” geometry may be considered, whereas in the second light evaluation, both the “real world” geometry and the “virtual world” geometry may be considered. Accordingly, in the example above, to compute the occlusion between objects in the “real world” on one hand, and occlusion between real and virtual objects in the real and virtual worlds, on the other hand, two occlusion buffers may be used and the occlusions in each buffer may be computed separately. For example, one occlusion buffer may be based on real world geometry (e.g. based on buffer G_{R}), while the other occlusion buffer may be based on the real and virtual world geometry (based on buffer G_{RV}).

In step 520, approximations may be used to determine global illumination. In some embodiments, the approximations may be based on both G_{RV} and the shadow maps and may be based further on screen space. By using approximations based on screen space, classical ray-tracing may be avoided. In some embodiments, techniques such as screen-space directional occlusion (SSDO) or screen-space ambient occlusion (SSAO) may be used as approximations to obtain global illumination. Screen space based techniques permit high speed determination of occlusion, while approximating illumination. SSDO facilitates high speed, real time and/or near real-time determination of occlusion and illumination, while accounting for directional information of incoming light. In some embodiments, SSDO may be performed as part of the lighting evaluation. In some embodiments, lighting evaluation may comprise steps 520, 530 and 540.

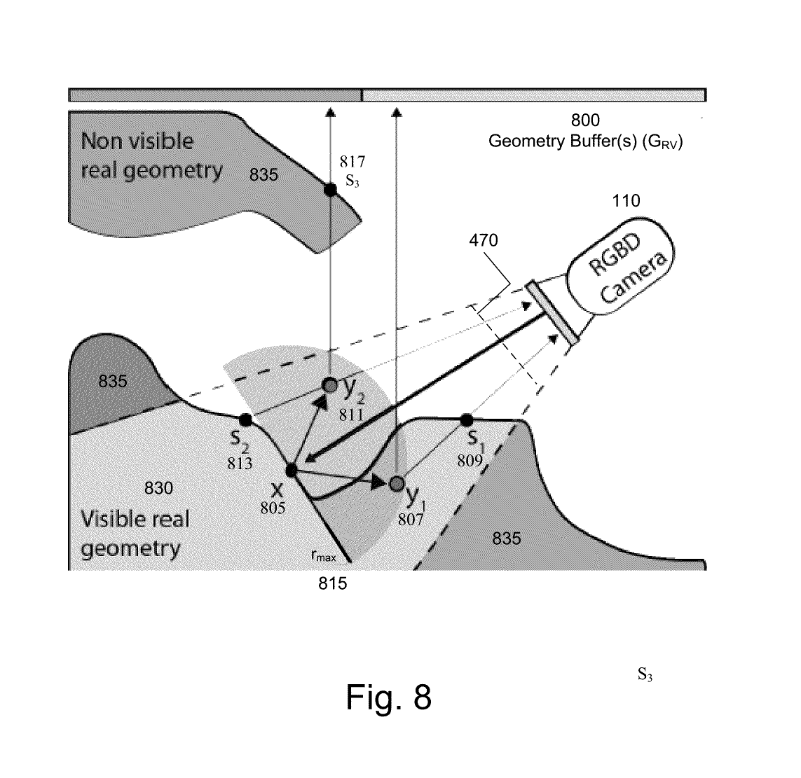

FIG. 8 illustrates an exemplary visibility computation in geometry buffer(s) G_{RV} 800 consistent with disclosed embodiments. In some embodiments, visibility for point X 805 may be computed using rays from point X 805 in a plurality of different directions. For example, the rays may cover portions of a sphere of radius rₘₐₓ 815, which is in the same coordinate system as the reconstructed geometry. In some embodiments, rays facing away from the surface normal at point X 805 may be ignored because they may be assumed to point into the geometry.

For surface point X 805, for a first ray through position Y₁ 807 in world space, point Y₁ 807 may be projected into camera space. The projection provides the look-up coordinates for the geometry buffer G_{RV} 800, which will return the surface point S₁ 809. In SSDO, for example, if point S₁ 809 is closer to the camera image plane than point X 805, then point X 805 may be considered as occluded in the ray direction.

Certain SSDO techniques may miss thin occluding objects in the scene. Further, because of the approximations used, some SSDO techniques may not accurately determine visibility for rays directed away from the camera. In some embodiments, to improve the quality of the visibility testing and to enable coherent shadowing between visible reconstructed geometry and non-visible reconstructed geometry, shadow geometry buffers covering the entire scene being modeled or workspace may be determined. In some embodiments, the shadow geometry buffers may be created using orthographic projection and may cover the entire reconstructed working space. In some embodiments, the shadow geometry buffers may be computed based on one or more dominant light directions. For example, the number of dominant light directions selected may be determined based on the realism desired, real-time performance desired, computing resources available, and/or user specified parameters.

Accordingly, in some embodiments, the visibility determination procedure above may be repeated for any additional shadow geometry buffers. For example, for point Y₂ 811, point X 805 may not be occluded along the point of view of camera 110 but may be determined to be occluded by point S₃ 817 in non-visible static geometry 835 in an additional shadow geometry buffer.

In some embodiments, the results obtained from the SSAO or SSDO global illumination approximations may be represented using SH. SH refers to a family of real-time rendering techniques that produce highly realistic shading and shadowing with comparatively little overhead. In some embodiments, the SSDO technique may be used with differential rendering techniques, which may be performed as part of light evaluation computation.

In step 530, light estimation may be performed based on the SH representation of the global illumination and color image 550. In some instances, lighting computation may use a real world model with online reconstructed geometry and inverse rendering techniques to compute diffuse lighting. Further, shading may be determined from light estimation and the global illumination represented as SH.

In step 540, AR rendering may be performed. For example, shading may be drawn over the background of the RGB image. The output may then be rendered as an AR image. In some embodiments, as outlined above, differential rendering techniques may be used to render the AR image. In some embodiments, method 700 may be performed by UE 100.

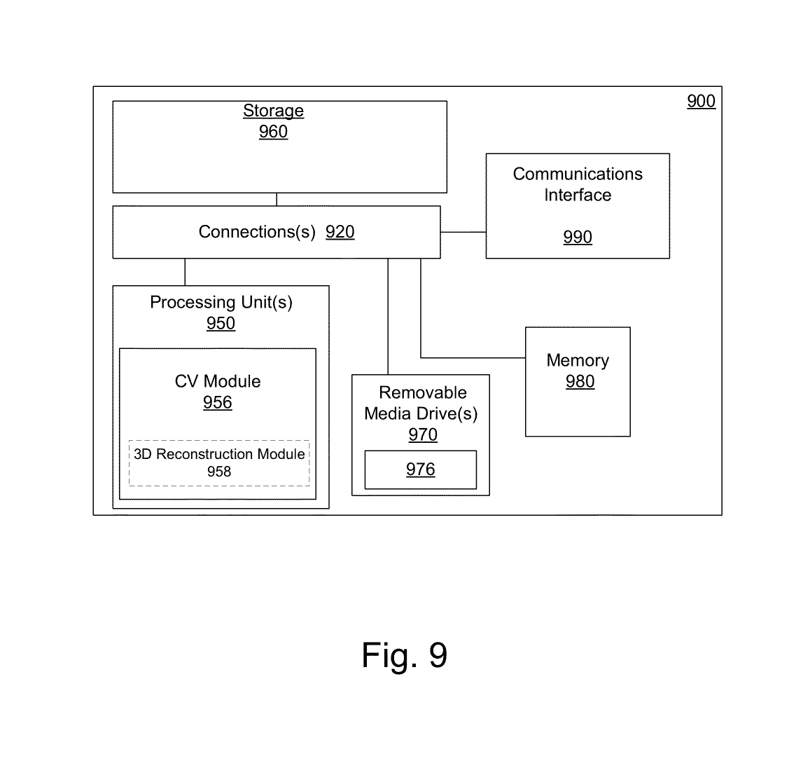

Reference is now made to FIG. 9, which is a schematic block diagram illustrating a server 900 enabled to facilitate AR lighting with dynamic geometry in a manner consistent with disclosed embodiments. In some embodiments, server 900 may perform portions of methods 500 and/or 600. In some embodiments, method 500 and/or 600 may be performed by processing unit(s) 950 and/or Computer Vision (CV) module 956. For example, the above methods may be performed in whole or in part by processing unit(s) 950 and/or CV module 956 in conjunction with one or more functional units on server 900 and/or in conjunction with UE 100.

In some embodiments, server 900 may be wirelessly coupled to one or more UEs 100 over a wireless network (not shown), which may one of a WWAN, WLAN or WPAN. In some embodiments, server 900 may include, for example, one or more processing unit(s) 950, memory 980, storage 960, and (as applicable) communications interface 990 (e.g., wireline or wireless network interface), which may be operatively coupled with one or more connections 920 (e.g., buses, lines, fibers, links, etc.). In certain example implementations, some portion of server 900 may take the form of a chipset, and/or the like.

Communications interface 990 may include a variety of wired and wireless connections that support wired transmission and/or reception and, if desired, may additionally or alternatively support transmission and reception of one or more signals over one or more types of wireless communication networks. Communications interface 990 may include interfaces for communication with UE 100 and/or various other computers and peripherals. For example, in one embodiment, communications interface 990 may comprise network interface cards, input-output cards, chips and/or ASICs that implement one or more of the communication functions performed by server 900. In some embodiments, communications interface 990 may also interface with UE 100 to perform reconstruction, send or update 3D model information for an scene, and/or receive data and/or instructions related to method 700.

Processing unit(s) 950 may use some or all of the received information to perform the requested computations and/or to send the requested information and/or results to UE 100 via communications interface 990. In some embodiments, processing unit(s) 950 may be implemented using a combination of hardware, firmware, and software. In some embodiments, processing unit(s) 950 may include Computer Vision (CV) Module 956, which may implement and execute computer vision methods, including AR procedures, shading, light and geometry estimation, ray casting, ray tracing, SLAM map generation, etc. In some embodiments, CV module 956 may comprise 3D reconstruction module 958, which may perform 3D reconstruction and/or provide/update 3D models of the scene. In some embodiments, processing unit(s) 950 may represent one or more circuits configurable to perform at least a portion of a data signal computing procedure or process related to the operation of server 900.

The methodologies described herein in flow charts and message flows may be implemented by various means depending upon the application. For example, these methodologies may be implemented in hardware, firmware, software, or any combination thereof. For a hardware implementation, the processing unit 650 may be implemented within one or more application specific integrated circuits (ASICs), digital signal processors (DSPs), digital signal processing devices (DSPDs), graphical processing units (GPUs), shaders, programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software may be stored in removable media drive 970, which may support the use of non-transitory computer-readable media 976, including removable media. Program code may be resident on non-transitory computer readable media 976 or memory 980 and may be read and executed by processing units 950. Memory may be implemented within processing units 950 or external to the processing units 950. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a non-transitory computer-readable medium 976 and/or memory 980. Examples include computer-readable media encoded with a data structure and computer-readable media encoded with a computer program. For example, non transitory computer-readable medium 976 including program code stored thereon may include program code to facilitate MR effects such as diminished and mediated reality effects from reconstruction in a manner consistent with disclosed embodiments.

Non-transitory computer-readable media may include a variety of physical computer storage media. A storage medium may be any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Other embodiments of non-transitory computer readable media include flash drives, USB drives, solid state drives, memory cards, etc. Combinations of the above should also be included within the scope of computer-readable media.

In addition to storage on computer readable medium, instructions and/or data may be provided as signals on transmission media to communications interface 690, which may store the instructions/data in memory 980, storage 960 and/or relayed the instructions/data to processing unit(s) 950 for execution. For example, communications interface 990 may receive wireless or network signals indicative of instructions and data. The instructions and data are configured to cause one or more processors to implement the functions outlined in the claims. That is, the communication apparatus includes transmission media with signals indicative of information to perform disclosed functions.

Memory 980 may represent any data storage mechanism. Memory 680 may include, for example, a primary memory and/or a secondary memory. Primary memory may include, for example, a random access memory, read only memory, non-volatile RAM, etc. While illustrated in this example as being separate from processing unit(s) 950, it should be understood that all or part of a primary memory may be provided within or otherwise co-located/coupled with processing unit(s) 950. Secondary memory may include, for example, the same or similar type of memory as primary memory and/or storage 960 such as one or more data storage devices 960 including, for example, hard disk drives, optical disc drives, tape drives, a solid state memory drive, etc.

In some embodiments, storage 960 may comprise one or more databases that may hold information pertaining to a scene, including 3D models, keyframes, information pertaining to virtual objects, etc. In some embodiments, information in the databases may be read, used and/or updated by processing unit(s) 950 during various computations.

In certain implementations, secondary memory may be operatively receptive of, or otherwise configurable to couple to a non-transitory computer-readable medium 976. As such, in certain example implementations, the methods and/or apparatuses presented herein may be implemented in whole or in part using non-transitory computer readable medium 976 that may include with computer implementable instructions stored thereon, which if executed by at least one processing unit(s) 950 may be operatively enabled to perform all or portions of the example operations as described herein. In some embodiments, computer readable medium 976 may be read using removable media drive 970 and/or may form part of memory 980.

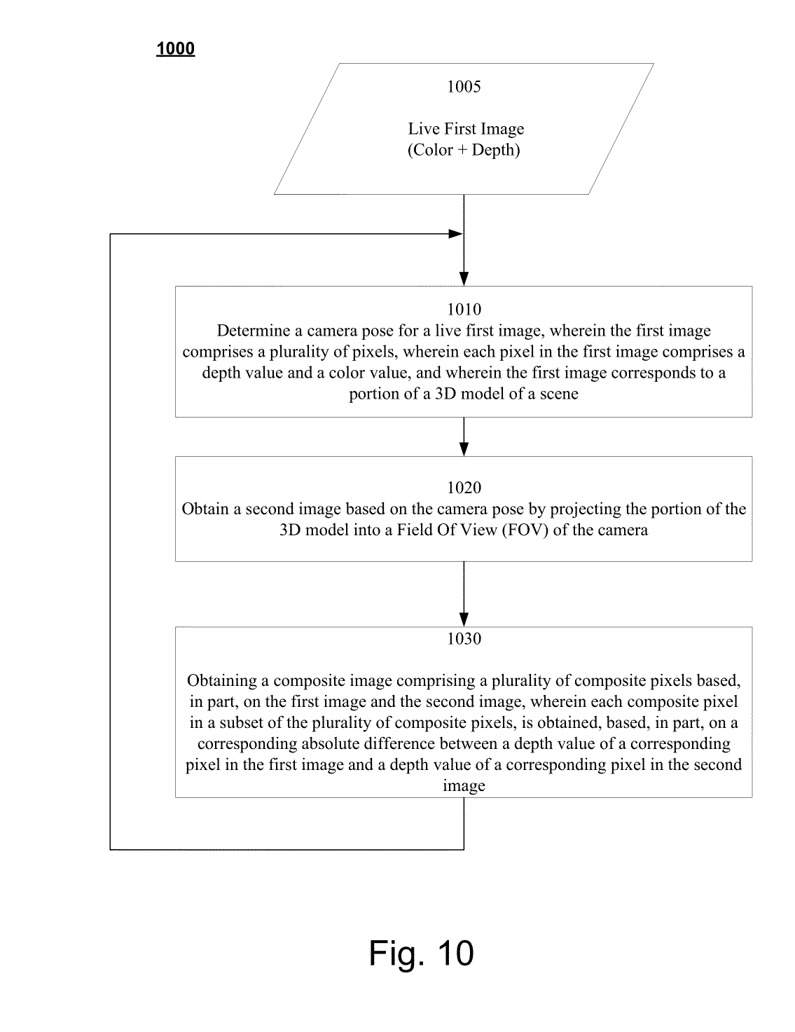

FIG. 10 shows a flowchart illustrating exemplary method 1000 for light estimation and AR rendering consistent with disclosed embodiments. In some embodiments, method 100 may be implemented by UE 100 and/or server 900. In some embodiments, in step 1010, a camera pose for a live first image 1005 may be determined, wherein the first image comprises a plurality of pixels, wherein each pixel in the first image comprises a depth value and a color value, and wherein the first image corresponds to a portion of a 3D model of a scene.

Next, in step 1020, a second image may be obtained based on the camera pose by projecting the portion of the 3D model into a Field Of View (FOV) of the camera.

In step 1030, a composite image may be obtained, comprising a plurality of composite pixels based, in part, on the first image and the second image, wherein each composite pixel in a subset of the plurality of composite pixels, is obtained, based, in part, on a corresponding absolute difference between a depth value of a corresponding pixel in the first image and a depth value of a corresponding pixel in the second image.

In some embodiments, each composite pixel in the subset may be obtained by selecting, as each composite pixel in the subset: the corresponding pixel in the first image when the corresponding absolute difference is greater than a threshold; or the corresponding pixel in the second image when the corresponding absolute difference is less than the threshold.

In some embodiments, each composite pixel in the subset may be obtained by determining, for each composite pixel in the subset: a first count of pixels in a neighborhood around the corresponding pixel in the first image, wherein a neighborhood pixel is included in the first count when a corresponding absolute difference between a color value of the neighborhood pixel and a color value of the corresponding pixel in the first image is below a first threshold, and a second count of pixels in the neighborhood, wherein a neighborhood pixel is included in the second count when a corresponding absolute difference between a depth value of the neighborhood pixel and a depth value of the corresponding pixel in the second image is below a second threshold. Further, for each composite pixel in the subset, a corresponding pixel in the second image may selected as the composite pixel, when the second count is greater than a fraction of the first count. In some embodiments, the corresponding pixel in the second image is selected as the composite pixel, when the second count is more than half the first count. In some embodiments, the neighborhood may be a polygon with a specified pixel distance around the corresponding pixel in the first image. In some embodiments, when the second count is not greater than a fraction of the first count, a depth value may be obtained, for each composite pixel in the subset, as a median of depth values of pixels in the neighborhood of the corresponding pixel in the first image.

In some embodiments, the method may further comprise, updating the 3D model of a scene by adding new information in the live image to the 3D model.

Further, in some embodiments, shadow maps may be determined based on the 3D model, the composite depth image, and a virtual model, in part, by resolving occlusions: (i) between one or more real world objects and one or more virtual objects in the FOV of the camera, wherein the virtual model comprises virtual objects, and (ii) between two or more of the real world objects. Global illumination may be computed based, in part, on the color values of pixels in the first image and the shadow maps. For example, the global illumination may be computed using SSDO approximations and the SSDO approximations may be projected into Spherical Harmonics (SH). In some embodiments, light estimation may be determined based, in part, on the global illumination and color values of pixels in the first image. A shading may be obtained based, in part, on the light estimation and the global illumination and an AR image may be rendered based on the shading and the color values of pixels in the first image.

The methodologies described herein may be implemented by various techniques depending upon the application. Any machine-readable medium tangibly embodying instructions may be used in implementing the methodologies described herein. For example, software code may be stored in a memory and executed by a processor unit. In some embodiments, the functions may be stored as one or more instructions or code on a computer-readable medium. Examples include computer-readable media encoded with a data structure and computer-readable media encoded with a computer program. Computer-readable media includes physical computer storage media.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method comprising, at a computing device:
determining a pose of a camera for a first image, wherein the first image comprises a plurality of pixels, wherein each pixel in the first image comprises a depth value and a color value, and wherein the first image corresponds to a portion of a 3D model of a scene;
obtaining a second image based on the camera pose by projecting the portion of the 3D model into a camera Field Of View (FOV) of the camera; and
obtaining a composite image comprising a plurality of composite pixels based, in part, on the first image and the second image, wherein each composite pixel in a subset of the plurality of composite pixels is obtained, based, at least in part, on a corresponding absolute difference between a depth value of a corresponding pixel in the first image and a depth value of a corresponding pixel in the second image.

2. The method of claim 1, wherein obtaining each composite pixel in the subset comprises:
selecting, as each composite pixel in the subset, the corresponding pixel in the first image when the corresponding absolute difference is greater than a threshold; or
selecting, as each composite pixel in the subset, the corresponding pixel in the second image when the corresponding absolute difference is less than the threshold.

3. The method of claim 1, wherein obtaining each composite pixel in the subset comprises:
determining, for each composite pixel in the subset:
a first count of pixels in a neighborhood around the corresponding pixel in the first image, wherein a neighborhood pixel is included in the first count when a corresponding absolute difference between a color value of the neighborhood pixel and a color value of the corresponding pixel in the first image is below a first threshold, and
a second count of pixels in the neighborhood, wherein a neighborhood pixel is included in the second count when a corresponding absolute difference between a depth value of the neighborhood pixel and a depth value of the corresponding pixel in the second image is below a second threshold; and
selecting, as each composite pixel in the subset, the corresponding pixel in the second image, when the second count is greater than a fraction of the first count.

4. The method of claim 3, wherein the corresponding pixel in the second image is selected when the second count is more than half the first count.

5. The method of claim 3, wherein the neighborhood is a polygon shaped region with a specified pixel distance around the corresponding pixel in the first image.

6. The method of claim 3, further comprising, at the computing device:
obtaining, for each composite pixel in the subset, a corresponding depth value as a median of depth values of pixels in the neighborhood, when the second count is not greater than a fraction of the first count.

7. The method of claim 1, further comprising:
updating the 3D model by adding new information in the first image to the 3D model.

8. The method of claim 1, further comprising, at the computing device:
determining at least one shadow map based on the 3D model, the composite image, and a virtual model, in part, by resolving occlusions: (i) between one or more real world objects and one or more virtual objects in the FOV of the camera, wherein the virtual model comprises virtual objects, and (ii) between two or more of the real world objects;
computing a global illumination based, in part, on color values of pixels in the first image and the at least one shadow map;
determining a light estimation based, in part, on the global illumination and color values of pixels in the first image; and
obtaining a shading based, in part, on the light estimation and the global illumination.

9. The method of claim 8, wherein the global illumination is computed using Screen Space Directional Occlusion (SSDO) approximations and the method further comprises:
projecting the SSDO approximations into Spherical Harmonics (SH).

10. The method of claim 8, further comprising, at the computing device:
rendering an Augmented Reality (AR) image based on the shading and the color values of pixels in the first image.

11. A device comprising:
a camera comprising a depth sensor to obtain a first image, comprising a plurality of pixels, wherein each pixel in the first image comprises a depth value and a color value, and wherein the first image corresponds to a portion of a 3D model of a scene; and
a processor coupled to the camera, wherein the processor is configured to:
determine a camera pose for the first image;
obtain a second image based on the camera pose by projecting the portion of the 3D model into a Field Of View (FOV) of the camera; and
obtain a composite image comprising a plurality of composite pixels based, in part, on the first image and the second image, wherein each composite pixel in a subset of the plurality of composite pixels, is obtained, based, at least in part, on a corresponding absolute difference between a depth value of a corresponding pixel in the first image and a depth value of a corresponding pixel in the second image.

12. The device of claim 11, wherein, to obtain each composite pixel in the subset, the processor is configured to:
select, as each composite pixel in the subset, the corresponding pixel in the first image when the corresponding absolute difference is greater than a threshold; or
select, as each composite pixel in the subset, the corresponding pixel in the second image when the corresponding absolute difference is less than the threshold.

13. The device of claim 11, wherein to obtain each composite pixel in the subset, the processor is configured to:
determine, for each composite pixel in the subset:
a first count of pixels in a neighborhood around the corresponding pixel in the first image, wherein a neighborhood pixel is included in the first count when a corresponding absolute difference between a color value of the neighborhood pixel and a color value of the corresponding pixel in the first image is below a first threshold, and
a second count of pixels in the neighborhood, wherein a neighborhood pixel is included in the second count when a corresponding absolute difference between a depth value of the neighborhood pixel and a depth value of the corresponding pixel in the second image is below a second threshold; and
select, as each composite pixel in the subset, the corresponding pixel in the second image, when the second count is greater than a fraction of the first count.

14. The device of claim 13, wherein the processor is configured to select the corresponding pixel in the second image when the second count is more than half the first count.

15. The device of claim 13, wherein the neighborhood is a polygon with a specified pixel distance around the corresponding pixel in the first image.

16. The device of claim 13, wherein the processor is further configured to:
obtain, for each composite pixel in the subset, a corresponding depth value as a median of depth values of pixels in the neighborhood, when the second count is not greater than a fraction of the first count.

17. The device of claim 11, wherein the processor is further configured to:
update the 3D model by adding new information in the live image to the 3D model.

18. The device of claim 11, wherein the processor is further configured to:
determine at least one shadow map based on the 3D model, the composite image, and a virtual model, in part, by resolving occlusions: (i) between one or more real world objects and one or more virtual objects in the FOV of the camera, wherein the virtual model comprises virtual objects, and (ii) between two or more of the real world objects;
compute global illumination based, in part, on color values of pixels in the first image and the at least one shadow map;
determine light estimation based, in part, on the global illumination and the color values of pixels in the first image; and
obtain a shading based, in part, on the light estimation and the global illumination.

19. The device of claim 18, wherein the processor computes the global illumination using Screen Space Directional Occlusion (SSDO) approximations and wherein the processor is further configured to:
project the SSDO approximations into Spherical Harmonics (SH).

20. The device of claim 18, wherein the processor is further configured to:
render an Augmented Reality (AR) image based on the shading and the color values of pixels in the first image.

21. A device comprising:
imaging means a comprising a depth sensing means, the imaging means to obtain a live first image, comprising a plurality of pixels, wherein each pixel in the first image comprises a depth value and a color value, and wherein the first image corresponds to a portion of a 3D model of a scene; and
processing means coupled to the imaging means, wherein the processing means comprises:
means for determining an imaging means pose for the first image;
means for obtaining a second image based on the imaging means pose by projecting the portion of the 3D model into a Field Of View (FOV) of the imaging means; and
means for obtaining a composite image comprising a plurality of composite pixels based, in part, on the first image and the second image, wherein each composite pixel in a subset of the plurality of composite pixels, is obtained, based, at least in part, on a corresponding absolute difference between a depth value of a corresponding pixel in the first image and a depth value of a corresponding pixel in the second image.

22. The device of claim 21, wherein, means for obtaining each composite pixel in the subset comprises:
means for selecting, as each composite pixel in the subset, the corresponding pixel in the first image when the corresponding absolute difference is greater than a threshold; or
means for selecting, as each composite pixel in the subset, the corresponding pixel in the second image when the corresponding absolute difference is less than the threshold.

23. The device of claim 21, wherein means for obtaining each composite pixel in the subset comprises:
means for determining, for each composite pixel in the subset:
a first count of pixels in a neighborhood around the corresponding pixel in the first image, wherein a neighborhood pixel is included in the first count when a corresponding absolute difference between a color value of the neighborhood pixel and a color value of the corresponding pixel in the first image is below a first threshold, and
a second count of pixels in the neighborhood, wherein a neighborhood pixel is included in the second count when a corresponding absolute difference between a depth value of the neighborhood pixel and a depth value of a corresponding pixel in the second image is below a second threshold; and
means for selecting, as each composite pixel in the subset, the corresponding pixel in the second image, when the second count is greater than a fraction of the first count.

24. The device of claim 23, wherein the means for selecting selects the corresponding pixel in the second image when the second count is more than half the first count.

25. The device of claim 23, further comprising:
means for obtaining, for each composite pixel in the subset, a corresponding depth value as a median of depth values of pixels in the neighborhood, when the second count is not greater than a fraction of the first count.

26. An article comprising:
a non-transitory computer readable medium comprising instructions that are executable by a processor to:
determine a camera pose for a live first image, wherein the first image comprises a plurality of pixels, wherein each pixel in the first image comprises a depth value and a color value, and wherein the first image corresponds to a portion of a 3D model of a scene;
obtain a second image based on the camera pose by projecting the portion of the 3D model into a Field Of View (FOV) of the camera; and
obtain a composite image comprising a plurality of composite pixels based, in part, on the first image and the second image, wherein each composite pixel in a subset of the plurality of composite pixels, is obtained, based, at least in part, on a corresponding absolute difference between a depth value of a corresponding pixel in the first image and a depth value of a corresponding pixel in the second image.

27. The article of claim 26, wherein the instructions are further executable by the processor to:
select, as each composite pixel in the subset, the corresponding pixel in the first image when the corresponding absolute difference is greater than a threshold; or
select, as each composite pixel in the subset, the corresponding pixel in the second image when the corresponding absolute difference is less than the threshold.

28. The article of claim 26, wherein the instructions are further executable by the processor to:
determine, for each composite pixel in the subset:
a first count of pixels in a neighborhood around the corresponding pixel in the first image, wherein a neighborhood pixel is included in the first count when a corresponding absolute difference between a color value of the neighborhood pixel and a color value of the corresponding pixel in the first image is below a first threshold, and
a second count of pixels in the neighborhood, wherein a neighborhood pixel is included in the second count when a corresponding absolute difference between a depth value of the neighborhood pixel and a depth value of the corresponding pixel in the second image is below a second threshold; and
select, as each composite pixel in the subset, a corresponding pixel in the second image, when the second count is greater than a fraction of the first count.

29. The article of claim 28, wherein the corresponding pixel in the second image is selected when the second count is more than half the first count.

30. The article of claim 28, wherein the instructions are further executable by the processor to:
obtain, for each composite pixel in the subset, a corresponding depth value as a median of depth values of pixels in the neighborhood of the corresponding pixel in the first image, when the second count is not greater than a fraction of the first count.
